(19) United States
(12) Patent Application Publication
(10) Pub. No.: US 2012/0044211 A1
(43) Pub. Date: Feb. 23, 2012

(54) OPTICAL TOUCH LOCATING SYSTEM AND METHOD THEREOF

(75) Inventors: CHUNG-WEN HSU, Kaohsiung City (TW); CHUNG-FUU MAO, Hsin-Chu City (TW); WEI-CHOU CHEN, Hsin-Chu City (TW)

(73) Assignee: WALTOP INTERNATIONAL CORPORATION, HSIN-CHU CITY (TW)

(21) Appl. No.: 13/042,306

(22) Filed: Mar. 7, 2011

(30) Foreign Application Priority Data
Aug. 17, 2010 (TW) 099127390

(51) Int. Cl. G06F 3/042

(52) U.S. Cl. 345/175; 178/18.09

(57) ABSTRACT

An optical touch locating system and method thereof is disclosed herein. The method includes the following steps. A step is used for activating the coordinate detecting module. A step is used for calculating the distance between two optical touch apparatuses. A step is used for sequentially locating a plurality of anchor points. When indicating to detect a first anchor point, a step is used to touch one of four corners on a display device by a touch object. A step is used for sequentially detecting and locating the remaining anchor points. At final step, according to the distance between two optical touch apparatuses and the coordinates of the anchor points, the touch working area. is confirmed.

### CROSS-REFERENCE TO RELATED APPLICATIONS

The entire contents of Taiwan Patent Application No. 099127390, filed on Aug. 17, 2010, from which this application claims priority, are incorporated herein by reference.

### BACKGROUND OF THE INVENTION

1. Field of the Invention

The present invention is related to an optical touch locating system and method thereof, and more particularly to a locating system and method thereof used to enhance the touch accuracy of the optical touch device.

2. Description of Related Art

Touch function is one of the most significant functions which customers want to have in their electronic devices. Because customers can use their instinct to operate the electronic devices to lower the difficulty operation of the electronic devices, those electronic devices with touch function are easy to sell in the market.

However, in the large scale monitor or projection screen, the portable touch module is required for the large scale monitor or projection screen to include the touch function. Because the conventional portable touch module or large size touch apparatus is disposed in the fixed location near the touch active area, the detective touch region is predefined and realized by the touch module. If the portable touch module is not disposed at the fixed location, the portable touch module is not able to detect the different size touch active area or display device exactly and the error detection of the touch point coordinate would occur and the accuracy of the touch detection is affected.

Therefore, there is a need to develop a locating method, which is capable for the portable touch module to use in different size display device and the portable touch module can realize the size of the touch active area and the accuracy of the touch detection is enhanced.

### SUMMARY OF THE INVENTION

One object of the present invention is to provide an optical touch locating system, and the optical touch apparatus is capable to use in different size display device without decreasing the accuracy of the touch detection.

Another object of the present invention is to provide an optical touch locating method, and the locating method is able to determine a touch active area where the touch optical apparatus needs to recognize the touch detection so as to enhance the accuracy of the touch detection.

According to the objects described above, an optical touch locating system is disclosed in the present invention and includes two optical touch apparatuses and a coordinate detecting module. Each of the optical touch apparatuses includes an optical transmitting module and an optical receiving module. The optical transmitting module is configured to transmit a plurality of optical signals and the optical receiving module is configured to receive the reflected optical signals. The coordinate detecting module is configured to determine a touch active area in accordance with the reflected optical signals. The coordinate detecting module detects a plurality of touch point coordinates in accordance with the optical signals reflected from a pointer so as to identify the touch active area.

The present invention also discloses an optical touch system locating method which includes the following steps: activating a coordinate detecting module; calculating a distance between two optical touch apparatuses; sequentially locating a plurality of touch point coordinates; touching one of four corners in a display device by a pointer when indicating to detect the first touch point coordinate and sequentially detecting the remaining touch point coordinates; and identifying a touch active area in accordance with the distance between two optical touch apparatuses and the touch point coordinates.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a view illustrating an optical touch locating system in an embodiment of the present invention;

FIG. 2 is a view illustrating an optical touch locating system in another embodiment of the present invention;

FIGS. 3A and 3B are schematic block diagrams illustrating the optical touch apparatus of the locating system in one embodiment of the present invention;

FIGS. 4A-4D are block diagrams of the optical touch apparatus in another embodiment of the present invention;

FIG. 5 is a flow chart illustrating the locating method of the optical touch apparatus in the present invention; and

FIG. 6 is a schematic block diagram illustrating an optical touch apparatus in another embodiment of the present invention.

### DESCRIPTION OF THE PREFERRED EMBODIMENT

The detailed description of the present invention will be discussed in the following embodiments, which are not intended to limit the scope of the present invention, and can be adapted for other applications. While drawings are illustrated in detail, it is appreciated that the quantity of the disclosed components may be greater or less than that disclosed, except where expressly restricting the amount of the components.

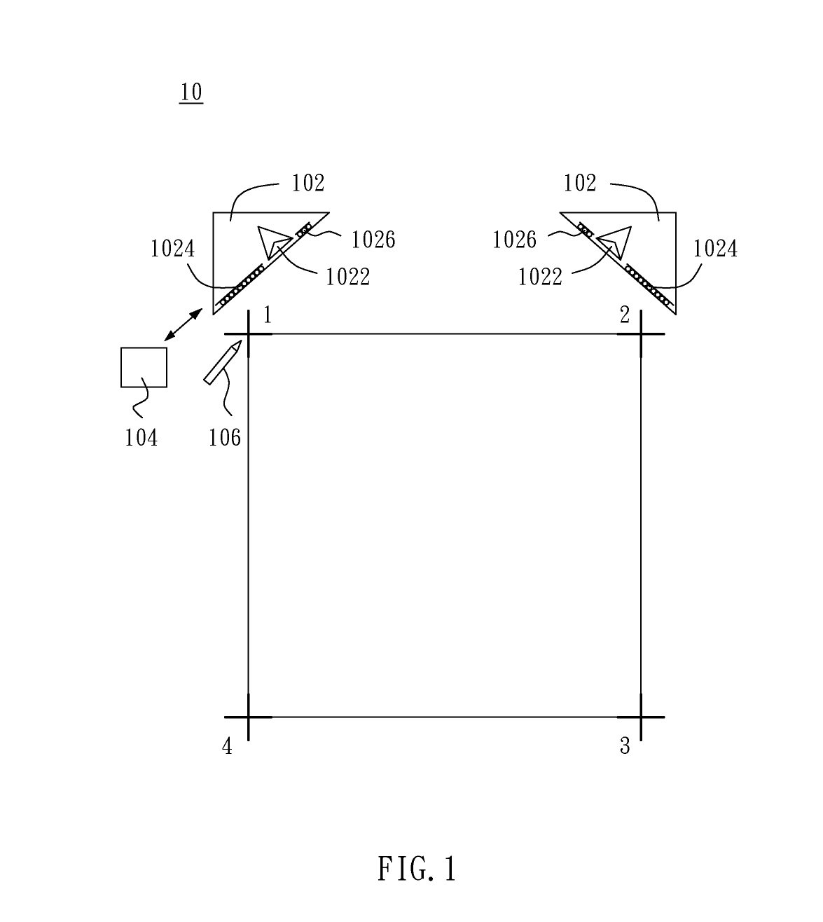

FIG. 1 is a view illustrating an optical touch locating system 10 in the present invention. As shown in FIG. 1, there are two optical touch apparatuses 102 in the present embodiment, and the two optical touch apparatuses 102 are disposed at the top-right and top-left sides of the display device (such as large scale panel or projection screen) or the touch active area. The optical touch apparatus 102 is a detective device configured to detect the directional light source (such as infrared ray or laser light). The optical touch apparatus 102 includes an optical transmitting module 1022 and an optical receiving module 1024. After the two optical touch apparatuses 102 are disposed at the fixed positions, the optical transmitting module 1022 in one of the optical touch apparatuses 102 will transmit optical signals and the optical receiving module 1024 in another one of the optical touch apparatuses 102 will receive the optical signals so as to determine the distance between the two optical touch apparatuses 102. It should be noted that both of the optical touch apparatuses 102 are respectively configured to include an optical transmitting module 1022 and an optical receiving module 1024 and it is not necessary to specify which one optical transmitting modules 1022 in one of the two optical touch apparatuses 102 to transmit the optical signals or which one of the optical receiving modules 1024 in another one of the optical touch apparatuses 102 to receive the optical signals. Subsequently, a coordinate detecting module 104 is configured to detect the touch point coordinate. For example, when the coordinate detecting module 104 is going to detect the touch point 1, a pointer 106 (such as a stylus) will touch the display device or the touch active area, and the optical touch apparatus 102 disposed at right and left hand side will detect the touch point coordinate of the pointer 106 and mark it as top-left. After that, the touch point 2, the touch point 3 and the touch point 4 are sequentially marked as top-right, bottom-right and bottom-left. After these four touch points are detected, the region surrounded by these four touch points is the touch active area.

It should be noted that the coordinate detecting module 104 can be a software application or a firmware (not shown) installed inside or outside the electronic device. The electronic device will detect the touch active area by turning on the coordinate detecting module 104. In addition, the order of detecting these touch points by the coordinate detecting module 104 is not all the same, and the user can change the order by himself. According to the detection of the touch points, the electronic device is able to realize that the optical touch apparatuses 102 are perpendicularly or horizontally disposed in accordance with the signal strength and the detective sequence of the optical touch apparatuses 102. In a different embodiment, in order to enhance the accuracy of the distance detection of the two optical touch apparatuses 102, the optical touch apparatus 102 further includes a distance-deciding receiving module 1026, and the distance-deciding receiving module 1026 will receive the optical signal from the optical transmitting module 1022 to accurately determine the distance between two optical touch apparatuses 102 so as to enhance the detective accuracy of the touch active area.

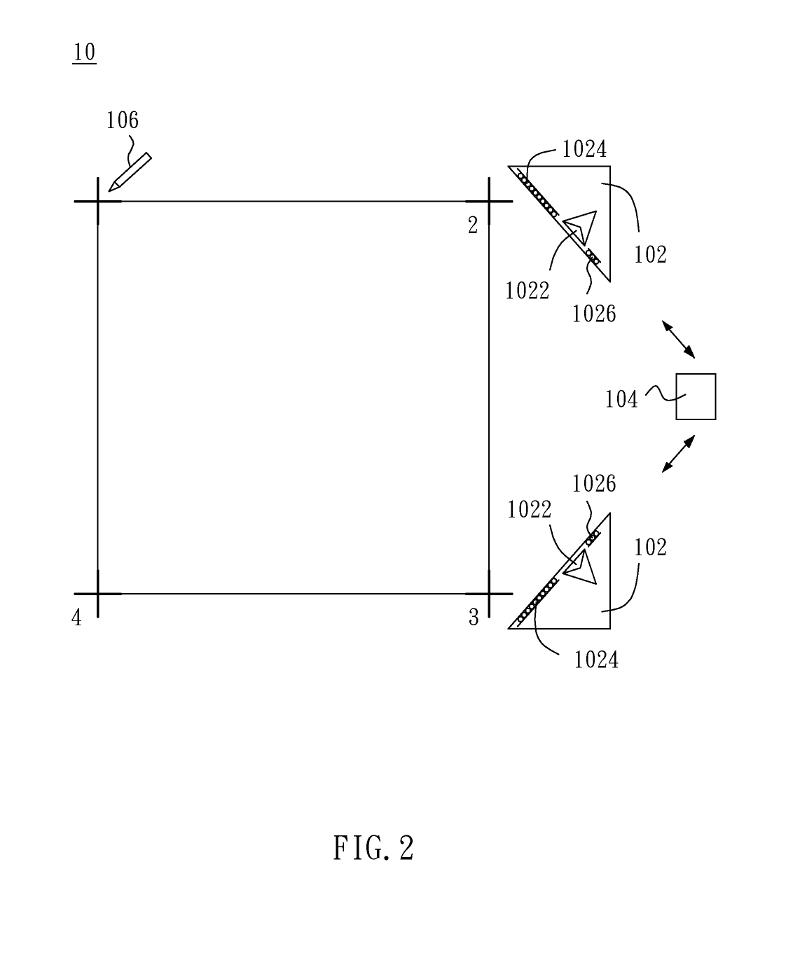

FIG. 2 is a view illustrating an optical touch locating system 10 in another embodiment of the present invention. As shown in FIG. 2, the two optical touch apparatuses 102 are disposed at the top-right and bottom-right of the display device. As the embodiment shown in FIG. 1, the optical transmitting module 1022 in one of the optical touch apparatuses 102 will transmit the optical signals and the optical receiving module 1024 in another one of the optical touch apparatuses 102 will receive the optical signals so as to determine the distance between these two optical touch apparatuses 102. Subsequently, the pointer 106 will sequentially detect the touch points at four corners to confirm the touch active area. It should be noted that, according to the embodiment in FIG. 1 and FIG. 2, the two optical touch apparatuses 102 are able to switch the disposed location and the locating system 10 in the present invention can determine the touch active area.

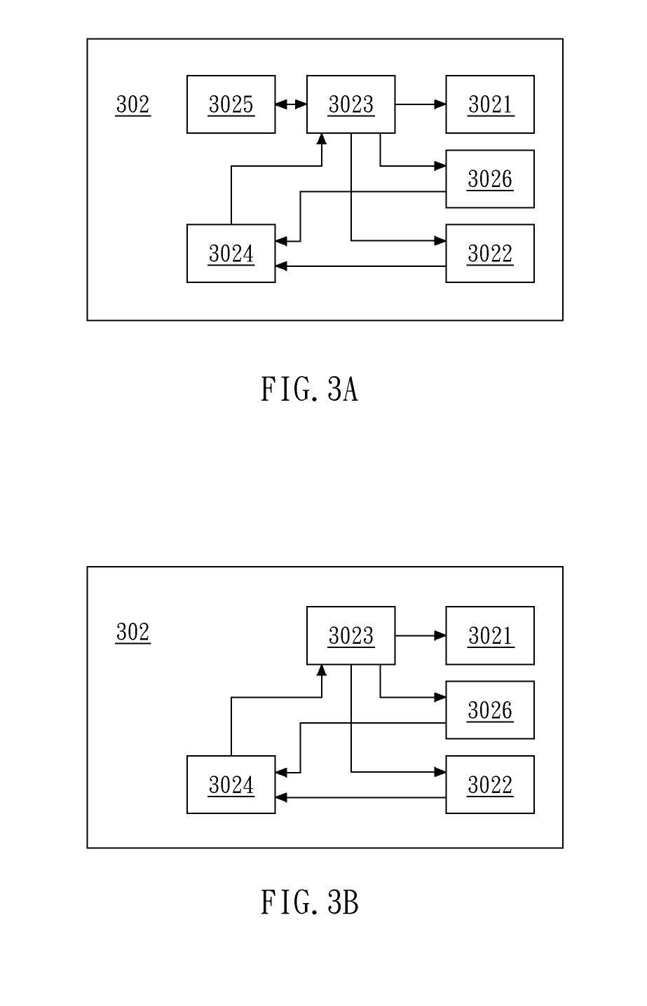

FIG. 3A is a schematic block diagram illustrating the optical touch apparatus of the locating system in the present invention. As shown in FIG. 3A, the optical touch apparatus 302 includes an optical transmitting module 3021, an optical receiving module 3022, a controller 3023 and a signal processing circuit 3024. The optical transmitting module 3021 is configured to transmit the directional light source (such as infrared ray or laser light) and the optical receiving module 3022 is configured to receive the reflected light source. The controller 3023 is respectively and electrically connected to the optical transmitting module 3021, the optical receiving module 3022 and the signal processing circuit 3024 and configured to output signals to control the signal transmitting and receiving in the optical transmitting module 3021, the optical receiving module 3022 and the signal processing circuit 3024. The signal processing circuit 3024 is electrically connected to the optical receiving module 3022 and configured to collect the reflected optical signal so as to determine the touch position. The signal processing circuit 3024 further converts the touch position signal to be a coordinate data and transmits the coordinate data to the electronic device through a transmitting interface 3025 (such as a universal serial bus, or USB) to determine the touch active area. However, in a different embodiment, the optical touch apparatus 302 directly transmits the touch coordinate data without the transmitting interface 3025 (wireless communication such as bluetooth and so on), as shown in FIG. 3B and the touch active area can also be determined. Moreover, the optical touch apparatus 302 further includes a distance-deciding receiving module 3026. The distance-deciding receiving module 3026 can receive the reflected optical signal from the optical touch apparatus 302 to accurately determine the distance between the two optical touch apparatuses 302 so as to enhance the detective accuracy of the touch active area.

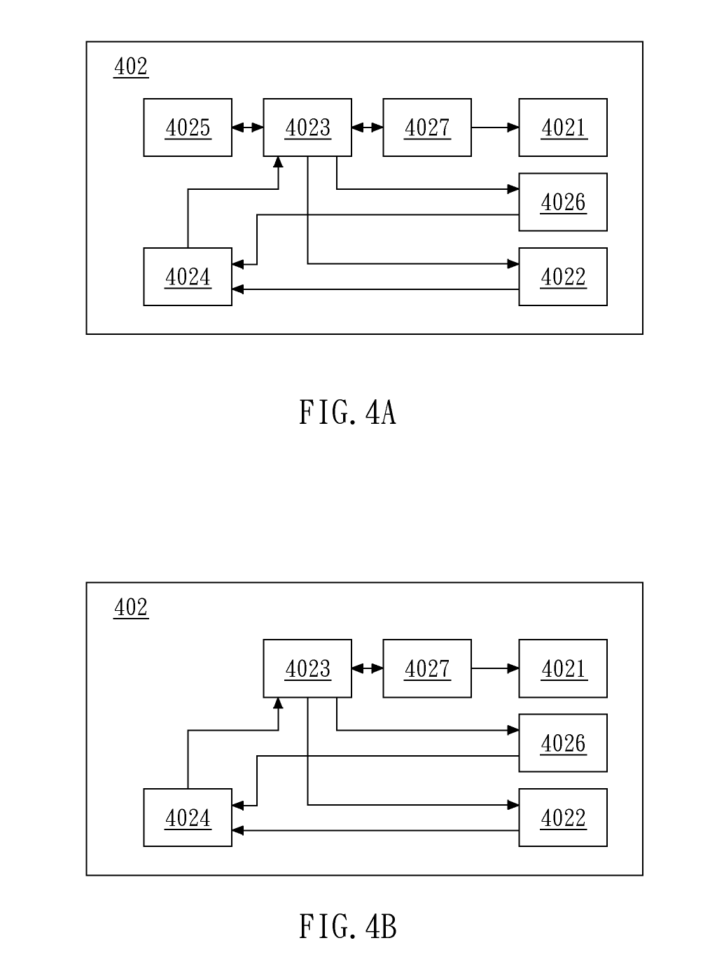

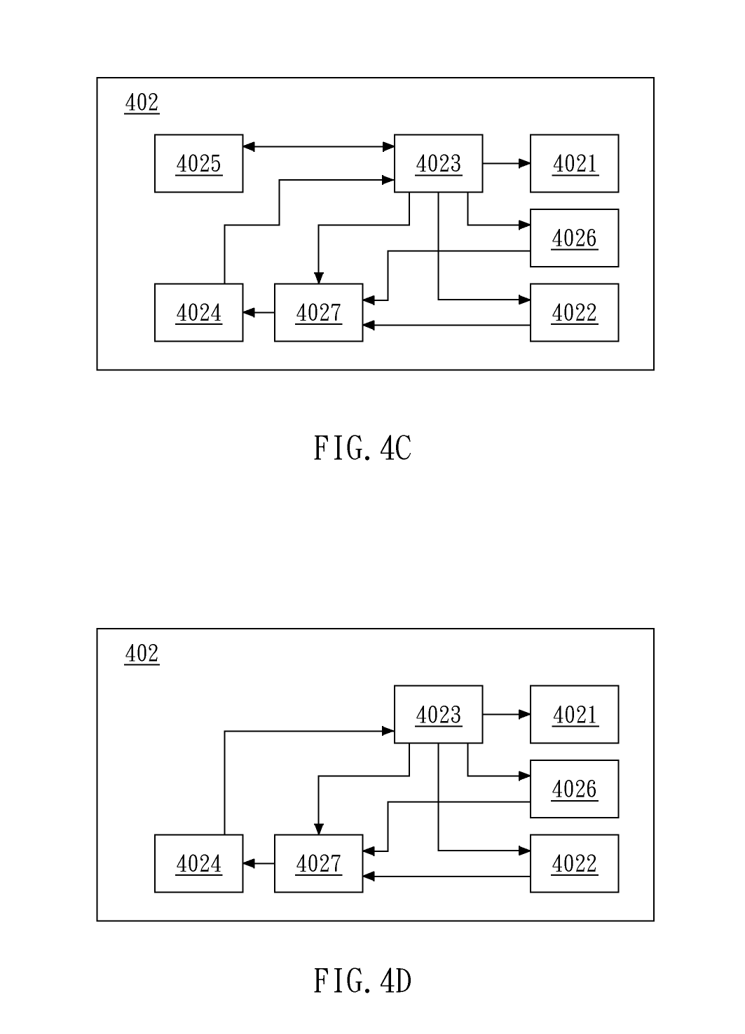

FIG. 4A is a block diagram of the optical touch apparatus in another embodiment of the present invention. As shown in FIG. 4A, the optical touch apparatus 402 also includes an optical transmitting module 4021, an optical receiving module 4022, a controller 4023 and a signal processing circuit 4024. Because the composition and the function of the optical touch apparatus 402 is similar to the optical touch apparatus 302 in FIG. 3, the detailed description of the function and the connection relationship of the optical touch apparatus 402 is omitted herein. The optical touch apparatus 402 is also able to work with a transmitting interface 4025 (as shown in FIG. 4A) or without a transmitting interface 4025 (as shown in FIG. 4B), and further includes a distance-deciding receiving module 4026. The difference between the optical touch apparatus 402 and the optical touch apparatus 302 in FIG. 3A is that the optical touch apparatus 402 further includes a gain control amplifier 4027. The gain control amplifier 4027 is disposed between the controller 4023 and the optical transmitting module 4021, and is configured to gain and amplify the signal strength transmitted from the optical transmitting module 4021.

FIG. 4C is a schematic block diagram illustrating one other optical touch apparatus in the present invention. As shown in FIG. 4C, the gain control amplifier 4027 of the optical touch apparatus 402 in the embodiment is configured to gain control the reflected optical signal received from the optical receiving module 4022 and transmits the gain reflected signal to the signal processing circuit 4024 for the next process. In addition, in a different embodiment, the optical touch apparatus 402 in FIG. 4C is also able to work without a transmitting interface 4025, as shown in 4D.

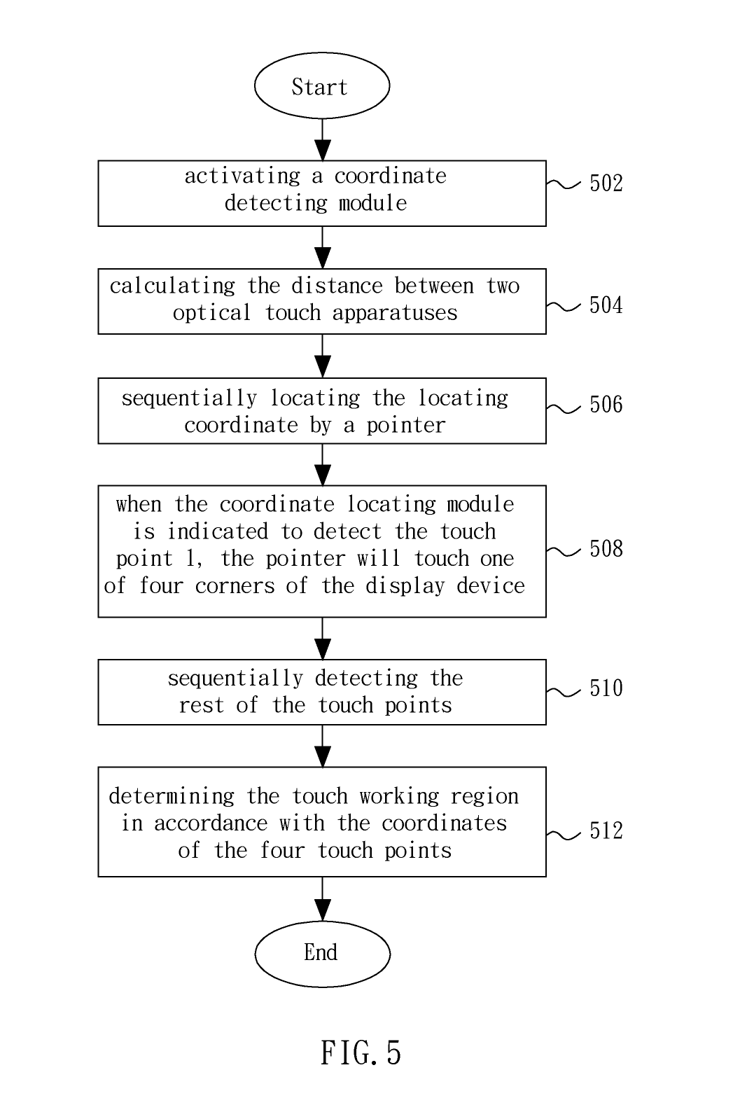

FIG. 5 is a flow chart illustrating the locating method of the optical touch apparatus in the present invention. As shown in FIG. 5, the locating method includes the following steps. In step 502, a coordinate detecting module is activated. In step 504, the distance between two optical touch apparatuses is calculated. In step 506, a pointer is used to sequentially locate the touch point coordinate. In step 508, when the coordinate locating module is indicated to detect the touch point 1, the pointer will touch one of four corners of the display device. In step 510, the remaining touch points are sequentially detected. In step 512, the touch active area is determined. It should be noted that the detective order of the touch points can be clockwise, counter-clockwise or any other sequences, and it is not limited herein.

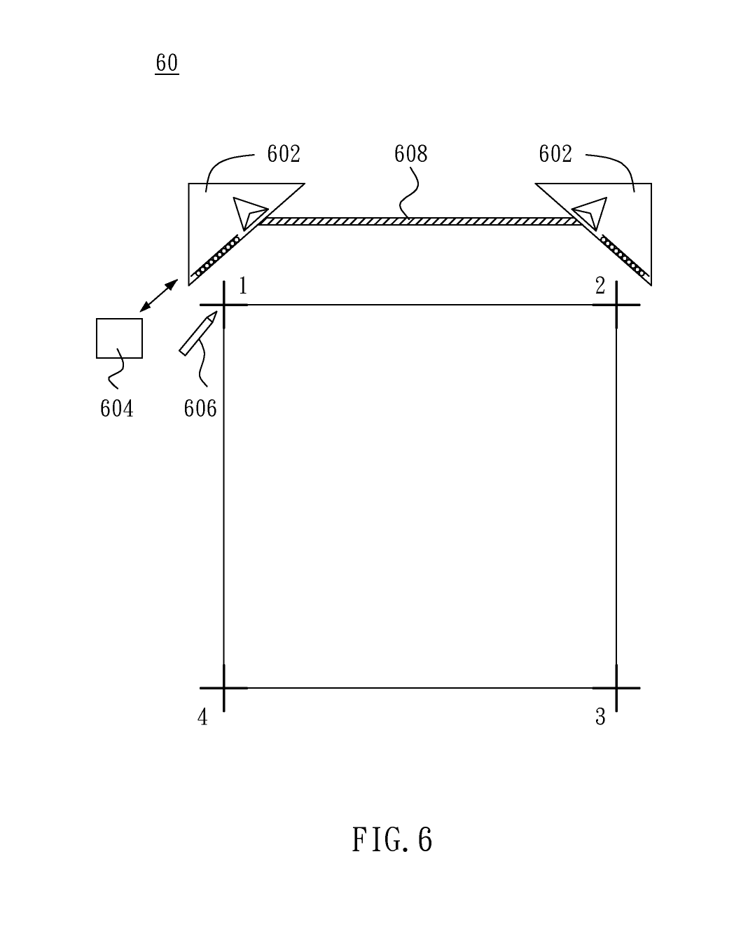

FIG. 6 is a schematic block diagram illustrating an optical touch apparatus in another embodiment of the present invention. In the present embodiment, a locating system 60 also includes two optical touch apparatuses 602, a coordinate detecting module 604 and a pointer 606. However, because the optical touch apparatuses 602 are disposed on the display device, the two optical touch apparatuses 602 are difficult to dispose at the same horizontal line to cause the error detection of the angle of the touch object, and the accuracy of the touch detection is reduced or the optical touch apparatus 602 is shaking to cause the detective error. In order to dispose the two optical touch apparatuses 602 at the same horizontal line and avoid the shaking, there is a horizontal rod 608 disposed between two optical touch apparatuses 602 to increase the disposed stability of the optical touch apparatuses 602. Moreover, it is able to make sure that the two optical touch apparatuses 602 are disposed at the same horizontal line because of the horizontal rod 608. In addition, the two optical touch apparatuses 602 are able to move horizontally over the horizontal rod 608 to fit with different size of the display device. If the optical touch apparatuses 602 are disposed on a larger scale panel, the distance between the optical touch apparatuses 602 is larger, and if the optical touch apparatuses 602 are disposed on a smaller scale panel, the distance between the optical touch apparatuses 602 is smaller. Because the fundamental principle of the locating system 60 in the present embodiment is similar to the previous embodiment, the detailed description is omitted herein.

Although specific embodiments have been illustrated and described, it will be appreciated by those skilled in the art that various modifications may be made without departing from the scope of the present invention, which is intended to be limited solely by the appended claims.

What is claimed is:

1. An optical touch locating system, comprising:
two optical touch apparatuses, and each of the optical touch apparatuses includes:
an optical transmitting module configured to transmit a plurality of optical signals; and
an optical receiving module configured to receive the reflected optical signals; and
a coordinate detecting module configured to determine a touch active area in accordance with the reflected optical signals;
wherein the coordinate detecting module detects a plurality of touch point coordinates in accordance with the optical signals reflected from a pointer so as to identify the touch active area.

2. The locating system of claim 1, wherein the optical receiving module in one of the optical touch apparatuses determines a distance between the two optical touch apparatuses in accordance with the optical signal reflected from another one of the optical touch apparatuses.

3. The locating system of claim 2, wherein the coordinate detecting module determines the touch active area in accordance with the touch point coordinates and the distance between the two optical touch apparatuses.

4. The locating system of claim 1, wherein each of the optical touch apparatuses further includes a signal processing circuit configured to calculate a touch point coordinate data in accordance with the optical signal reflected from the optical receiving module.

5. The locating system of claim 4, wherein each of the optical touch apparatuses further includes a controller configured to output a control signal so as to control the signals transmitting and receiving in the optical transmitting module, the optical receiving module and the signal processing circuit.

6. The locating system of claim 5, wherein each of the optical touch apparatuses further includes an I/O interface configured to transmit the touch point coordinate data to an electronic device.

7. The locating system of claim 6, wherein the I/O interface is a Universal Serial Bus (USB) interface.

8. The locating system of claim 1, wherein each of the optical touch apparatuses further includes a distance-deciding receiving module, and the distance-deciding receiving module in one of the optical touch apparatuses receives the optical signal reflected from another one of the optical touch apparatuses so as to accurately determine the distance between the two optical touch apparatuses.

9. The locating system of claim 8, wherein the touch active area is determined in accordance with the touch point coordinates and the distance between two optical touch apparatuses.

10. The locating system of claim 1, wherein the coordinate detecting module is a software application or a firmware.

11. The locating system of claim 1, wherein each of the optical touch apparatuses further includes a gain control amplifier configured to gain and amplify the optical signal.

12. The locating system of claim 1, wherein the locating system determines the disposing positions of the two optical touch apparatuses in accordance with the touch point coordinates.

13. An optical touch system locating method, comprising:
activating a coordinate detecting module;
calculating a distance between two optical touch apparatuses;
sequentially locating a plurality of touch point coordinates;
touching one of four corners in a display device by a pointer when indicating to detect the first touch point coordinate and sequentially detecting the remaining touch point coordinates; and
identifying a touch active area in accordance with the distance between two optical touch apparatuses and the touch point coordinates.

14. The locating method of claim 13, wherein the distance between the two optical touch apparatuses is determined by an optical receiving module.

15. The locating method of claim 13, wherein the distance between the two optical touch apparatuses is determined by a distance-deciding receiving module.

16. The locating method of claim 13 further determining the disposing positions of the two optical touch apparatuses in accordance with the signal strength of the touch point coordinates.

17. An optical touch locating system, comprising:
two optical touch apparatuses, and each of the optical touch apparatuses includes:
an optical transmitting module configured to transmit a plurality of optical signals;
an optical receiving module configured to receive the reflected optical signals; and
a distance-deciding receiving module configured to calculate a distance between two optical touch apparatuses in accordance with the reflected optical signals; and
a coordinate detecting module configured to determine a touch active area in accordance with the reflected optical signals;
wherein the coordinate detecting module locates to confirm a plurality of touch point coordinates in accordance with the optical signals reflected from a pointer so as to identify the touch active area.

18. The locating system of claim 17, wherein each of the optical touch apparatuses further includes a signal processing circuit configured to calculate a touch point coordinate data in accordance with the optical signal reflected from the optical receiving module.

19. The locating system of claim 18, wherein each of the optical touch apparatuses further includes a controller configured to output a control signal so as to control the signals transmitting and receiving in the optical transmitting module, the optical receiving module and the signal processing circuit.

20. The locating system of claim 19, wherein, each of the optical touch apparatuses further includes an I/O interface configured to transmit the touch point coordinate data to an electronic device.

21. The locating system of claim 17, wherein the coordinate detecting module is a software application or a firmware.

22. The locating system of claim 17, wherein the locating system determines the disposing position of the two optical touch apparatuses in accordance with the signal strength of the touch point coordinates.
